(19) United States
(12) Patent Application Publication
(10) Pub. No.: US 2013/0034405 A1
(43) Pub. Date: Feb. 7, 2013

(54) Screw with Helical Groove for Receiving Chippings

(71) Applicant: Kuo-Tai Hsu, Tainan City (TW)

(72) Inventor: Kuo-Tai Hsu, Tainan City (TW)

(21) Appl. No.: 13/196,948

(22) Filed: Aug. 3, 2011

(51) Int. Cl. F16B 25/08

(52) U.S. Cl. 411/386

(57) ABSTRACT

A screw includes a shank and a thread extending spirally around an outer circumference of the shank. The thread includes a plurality of thread convolutions each having a front flank facing an insertion end of the shank and a rear flank facing away from the insertion end. The screw further includes at least one helical groove. The helical groove is formed in the outer circumference of the shank and extends helically along bottom edges of one the front and rear flanks of the thread convolutions. The helical groove is adapted for receiving chippings produced by the thread screwing into articles to be fastened, allowing rapid insertion of the screw into the articles while providing a high tightening force.

### BACKGROUND OF THE INVENTION

1. Field of the Invention

The present invention relates to a screw and, more particularly, to a screw having at least one helical groove for receiving chippings. The screw is suitable for use with wood, building materials, or similar materials.

2. Description of the Related Art

Screws for wooden articles require easy, reliable fastening without causing damage to the wooden articles. A conventional screw generally includes a shank and at least one thread formed on the shank, so that the screw can be screwed into the articles which need to be fastened or interlocked. Furthermore, in order to enhance the speed of screwing the screw into the articles to be fastened, a design with slots disposing in the shank or crests of the thread for collecting or receiving chippings is already proposed. More specifically, chippings, wooden chippings for example, are produced when the screw is screwed into the articles to be fastened, and the slots can be used for receiving the chippings so that the chippings will not obstruct the process of screwing the screw into the articles, allowing rapid insertion of the screw into the articles and preventing disintegration of the materials of the articles. However, it is troublesome to manufacture the conventional chippings-receiving slots which extend lengthwise along the shank of the screw and intersect with the thread of the screw. Moreover, the conventional chippings-receiving slots are not beneficial for the fastening function of the screw. The same drawbacks are applied to the chippings-receiving slots disposing in the crests of the thread. In addition, the chippings-receiving slots formed in the crests of the thread only provide very limited rooms for receiving the chippings.

### BRIEF SUMMARY OF THE INVENTION

Thus, an objective of the present invention is to provide a screw to improve the aforementioned problems. The screw includes at least one helical groove for receiving clippings so that the screw can be screwed smoothly into articles to be fastened or interlocked together. The helical groove is easy and convenient to manufacture and allows rapid insertion of the screw into the articles to be fastened while increasing the engaging area for tightening purposes.

To achieve this and other objectives, a screw of the present invention includes a shank and a thread formed on the shank. The shank includes an outer circumference, an insertion end, and a head end spaced from the insertion end. The thread is helically formed on the outer circumference of the shank and extends from the insertion end towards the head end. The thread includes a plurality of thread convolutions each having a front flank facing the insertion end and a rear flank facing away from the insertion end of the shank. The screw further includes a first helical groove formed in the outer circumference of the shank and extending helically along bottom edges of one of the front and rear flanks of a portion of the thread convolutions of the thread.

Preferably, the shank further includes a straight section defined between the insertion end and the head end of the shank, and the first helical groove extends helically in the straight section of the shank. Each thread convolution has a thread height, and the first helical groove has a radial depth of 10% to 25% of the thread height. The first helical groove is substantially U-shape or V-shape in cross section.

In a preferred form, the screw further includes a second helical groove formed in the outer circumference of the shank and extending helically along bottom edges of the other one of the front and rear flanks of the thread convolutions of the thread.

Preferably, the second helical groove extends helically in the straight section of the shank. The second helical groove has a radial depth of 10% to 25% of the thread height, and the second helical groove is substantially U-shape or V-shape in cross section.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 is a perspective view of a screw in accordance with the present invention.

FIG. 2 is a side elevation of the screw of FIG. 1.

FIG. 3 is an enlarged view of a portion of the screw of FIG. 2.

FIG. 4 is an enlarged sectional view of a portion of the screw of FIG. 2.

FIG. 5 is a view illustrating use of the screw of FIG. 1.

### DETAILED DESCRIPTION OF THE INVENTION

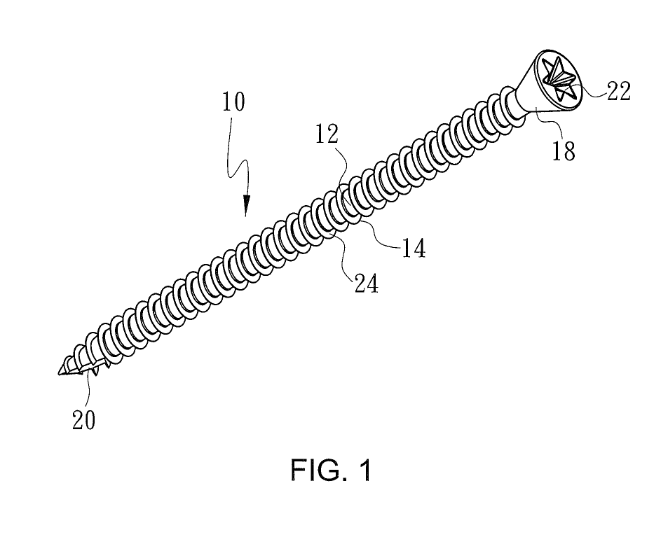

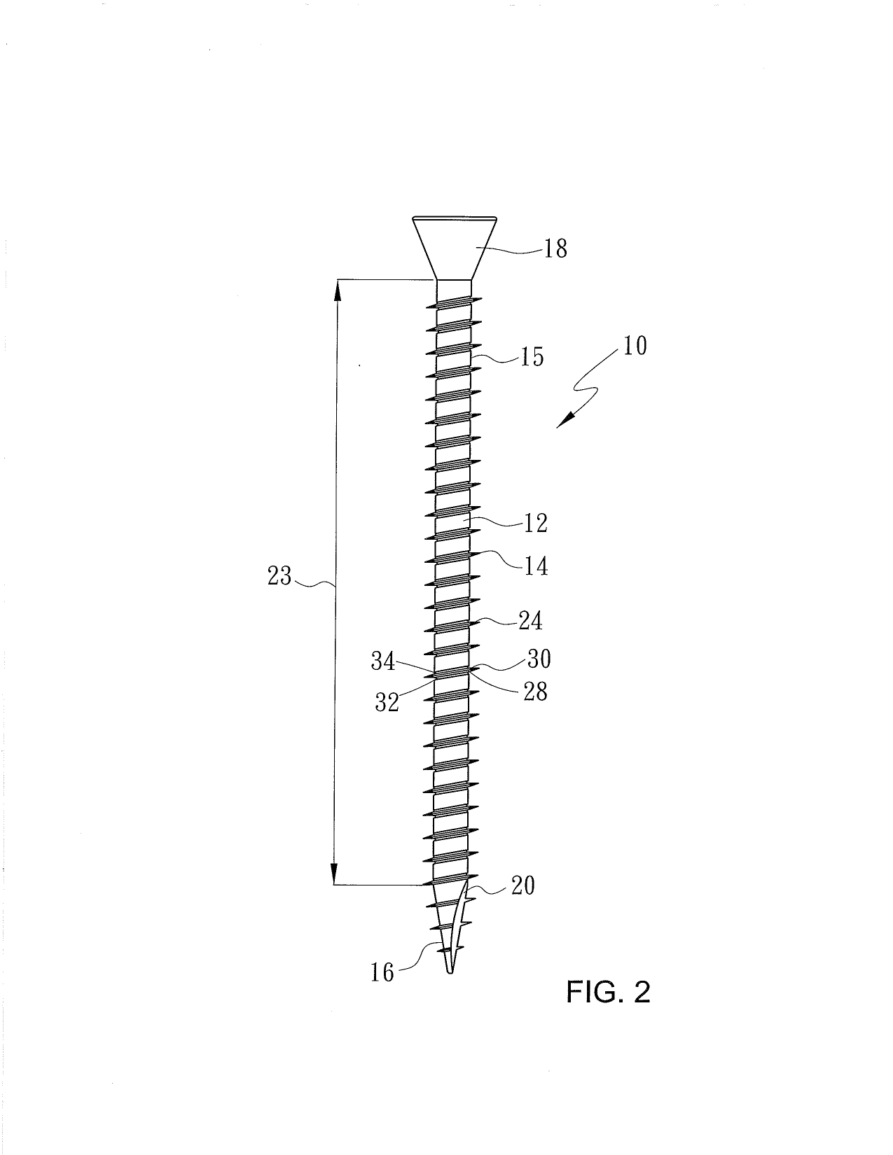

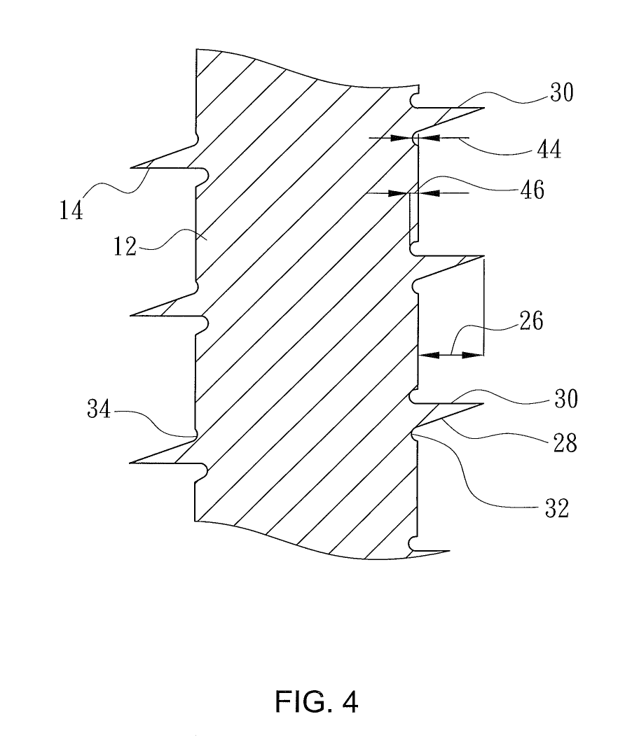

A screw according to the preferred teachings of the present invention is shown in FIGS. 1 through 5 of the drawings and generally designated 10. The screw 10 including a shank 12 and a continuous thread 14 formed on the shank 12. The shank 12 includes an outer circumference 15, an insertion end 16, and a head end 18 spaced from the insertion end 16. The insertion end 16 has a pointed end. The shank 12 further includes a flute 20 formed in the insertion end 16. The head end 18 has an outer diameter larger than a diameter of the shank 12 and includes a slot 22 formed in a top surface thereof for a screwdriver 21 (see FIGS) to insert into. A straight section 23 having a uniform diameter is defined between the insertion end 16 and the head end 18 of the shank 12.

The thread 14 is helically formed on the outer circumference 15 of the shank 12 and extends from the insertion end 16 towards the head end 18. In this embodiment, the thread 14 is disposed between the insertion end 16 and the head end 18. The thread 14 includes a plurality of thread convolutions 24 each having a thread height 26. A roughly equaled pitch is found between two adjacent thread convolutions 24. Further, each thread convolution 24 of the thread 14 includes a front flank 28 facing the insertion end 16 (i.e. located at an insertion side) and a rear flank 30 facing away from the insertion end 16 (i.e. located at an unscrewing side).

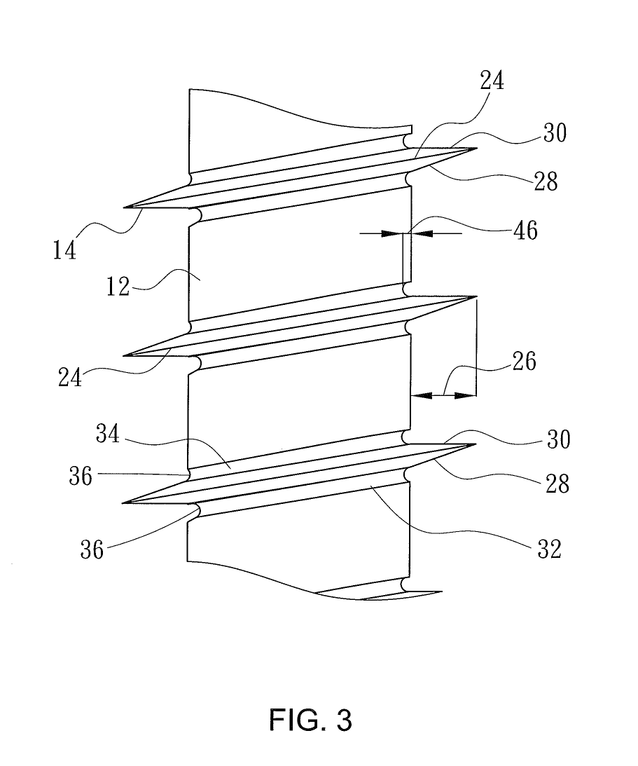

The screw 10 further includes first and second helical grooves 32 and 34. The first helical groove 32 is formed in the outer circumference 15 of the shank 12 and extends helically along bottom edges of the front flanks 28 of the thread convolutions 24 of the thread 14. The second helical groove 34 is formed in the outer circumference 15 of the shank 12 and extends helically along bottom edges of the rear flanks 30 of the thread convolutions 24 of the thread 14. In this embodiment, the first and second helical grooves 32 and 34 are disposed in the straight section 23 between the flute 20 and the head end 18. Further, each of the first and second helical grooves 32 and 34 is substantially U-shape in cross section. Namely, each of the first and second helical grooves 32 and 34 has an arc-shaped concave surface 36 (see FIG. 3). However, It can be appreciated that each of the first and second helical grooves 32 and 34 can be substantially V-shape in cross section.

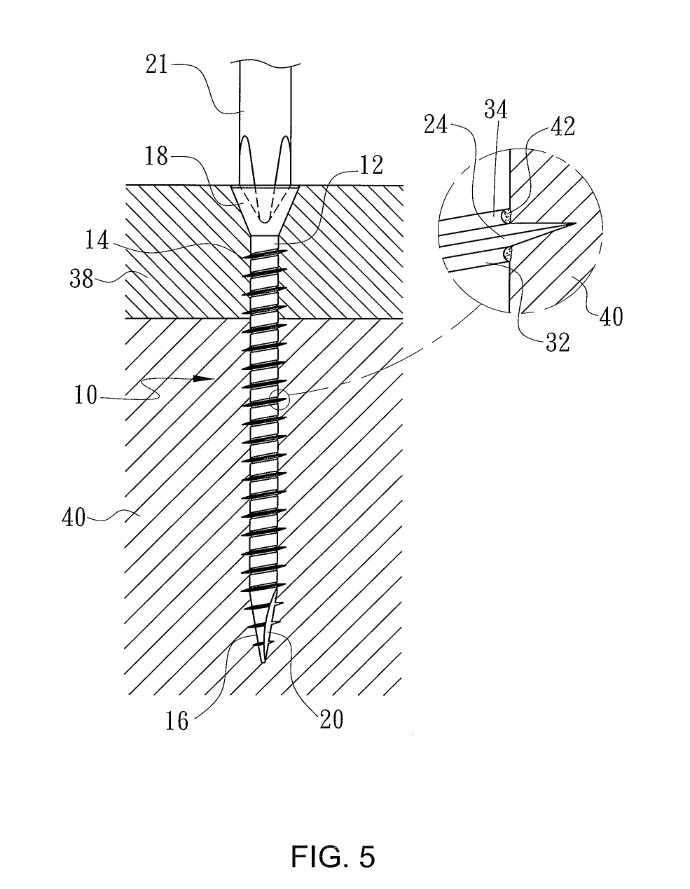

Referring to FIG. 5, when in use, the screw 10 is screwed into articles 38 and 40 (such as wooden articles) to be interlocked together with the insertion end 16. When the insertion end 16 of the screw 10 enters the article 38, the thread 14 and the flute 20 of the insertion end 16 will cut into the article 38, and chippings 42 are produced. The chippings 42 produced are squashed into the first helical groove 32 and the second helical groove 34 to accommodate. Therefore, the resistance for the screw 10 to screw into the articles 38 and 40 is reduced, and the screwing speed is enhanced. Besides, the articles 38 and 40 do not crack easily. Furthermore, the provision of the first and second helical grooves 32 and 34 can enhance the interlocking function between the screw 10 and the articles 38 and 40. More specifically, the first and second helical grooves 32 and 34 extend helically along the bottom edges of the front and rear flanks 28 and 30 of the thread convolutions 24 of the thread 14 respectively, so that the front and rear flanks 28 and 30 of the thread 14 have longer radial depths, increasing the engaging surfaces between the screw 10 and the articles 38 and 40. Therefore, when the screw 10 is screwed into the articles 38 and 40, the interlocking areas between the thread 14 and the articles 38 and 40 are increased to provide a high tightening force. In addition, the first and second helical grooves 32 and 34 extend helically along the bottom edges of the front and rear flanks 28 and 30 of the thread convolutions 24 of the thread 14 respectively, so that it is convenient to manufacture the first and second helical grooves 32 and 34 and the manufacturing cost can be reduced. The first helical groove 32 has a radial depth 44 which is approximately equal to 10% to 25% of the thread height 26. The second helical groove 34 also has a radial depth 46 of 10% to 25% of the thread height 26. When the radial depths 44 and 46 are more than 10% of the thread height 26, the screw 10 has a better effect for receiving the chippings 42. When the radial depths 44 and 46 are more than 25% of the thread height 26, it might weaken the structural strength of the shank 12.

Now that the basic teachings of the present invention have been explained, many extensions and variations will be obvious to one having ordinary skill in the art. For example, the screw 10 can have only the first helical groove 32 or the second helical groove 34. In addition, each of the first and second helical grooves 32 and 34 formed in the shank 12 is not limited to being a single continuous helical groove; in feasible embodiments, each of the first and second helical grooves 32 and 34 can be made up by a plurality of discontinuous groove sections extending along the bottom edges of the front and rear flanks 28 and 30 of a portion of the thread convolutions 24 respectively.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A screw comprising:
a shank including an outer circumference, an insertion end, and a head end spaced from the insertion end;
a thread helically formed on the outer circumference of the shank and extending from the insertion end towards the head end, with the thread including a plurality of thread convolutions each having a front flank facing the insertion end and a rear flank facing away from the insertion end of the shank; and
a first helical groove formed in the outer circumference of the shank and extending helically along bottom edges of one of the front and rear flanks of the thread convolutions of the thread.

2. The screw according to in claim 1, with the shank further including a straight section defined between the insertion end and the head end of the shank, and with the first helical groove extending helically in the straight section of the shank.

3. The screw according to claim 2, with each thread convolution having a thread height, and with the first helical groove having a radial depth of 10% to 25% of the thread height.

4. The screw according to claim 3, with the first helical grooves being substantially U-shape or V-shape in cross section.

5. The screw according to claim 1, further comprising: a second helical groove formed in the outer circumference of the shank and extending helically along bottom edges of the other one of the front and rear flanks of the thread convolutions of the thread.

6. The screw according to claim 5, with the shank further including a straight section defined between the insertion end and the head end of the shank, and with the first and second helical grooves extending helically in the straight section of the shank.

7. The screw according to claim 6, with each thread convolution having a thread height, with the first helical groove having a first radial depth of 10% to 25% of the thread height, and with the second helical groove having a second radial depth of 10% to 25% of the thread height.

8. The screw according to claim 7, with each of the first and second helical grooves being substantially U-shape or V-shape in cross section.
